(19) United States
(12) Patent Application Publication
(10) Pub. No.: US 2007/0288973 A1
(43) Pub. Date: Dec. 13, 2007

(54) Intelligent image quality engine

(75) Inventors: Arnaud Glatron, Santa Clara, CA (US); Frederic Sarrat, Paris (FR); Remy Zimmerman, Belmont, CA (US); Joseph Battelle, East Palo Alto, CA (US)

Correspondence Address: The Law Office of Deepti Panchawagh-Jain;c/o Intellevate, LLC, P.O. Box 52050, Minneapolis, MN, 55402, US

(73) Assignee: Logitech Europe S.A., Romanel-sur-Morges (CH)

(21) Appl. No.: 11/445,802

(22) Filed: Jun. 2, 2006

(51) Int. Cl. H04N 7/173

(52) U.S. Cl. 725/105

(57) ABSTRACT

In accordance with an embodiment of the present invention, the intelligent image quality engine intelligently manages different parameters related to image quality in the context of real-time capture of image data, in order to improve the end-user experience by using awareness of the environment, system, etc., and by controlling various parameters globally. Various image processing algorithms implemented include smart auto-exposure, frame rate control, image pipe controls, and temporal filtering.

### BACKGROUND OF THE INVENTION

1. Field of the Invention

This invention relates generally to digital cameras for capturing image data, and more particularly, to intelligently improving image quality.

2. Description of the Related Art

Digital cameras are increasingly being used by consumers to capture both still image and video data. Webcams, digital cameras connected to host systems, are also becoming increasingly common. Further, other devices that include digital image capturing capabilities, such as camera-equipped cell-phones and Personal Digital Assistants (PDAs) are sweeping the marketplace.

In general, the users of such digital cameras desire that the camera capture the image data (still and/or video) at the best possible image quality every time. Such best possible image quality is desired regardless of the environment conditions (e.g., low light, backlighting, etc.), the user's appearance (e.g., the color of the user's skin, hair, clothes, etc.), and other miscellaneous factors (e.g., the distance of the user from the camera, the type of application the user is using, such as Instant Messaging, etc.).

Some commonly available digital image capture devices attempt to improve image quality. However, there are several shortcomings in the approaches used. First, several commonly available digital image capture devices allow the user to proactively change various controls (e.g., flash, focus, etc.) to improve image quality. However, in many such cases, the digital capture devices do not display any intelligence, but rather simply implement the user's decisions. Second, even in situations where the digital image capture devices do use some intelligence (e.g., suggesting to the user that a flash should be used), each feature/control is used in isolation. Overall image quality, however, is dependent on the combination of these various features/controls, rather than on each one in isolation. For instance, addressing the low light in the environment in isolation may result in increased noise. Such interactions of these features are not taken into account in conventional digital image capture devices. Rather, treating specific problems in isolation can sometimes result in worsening of the overall image quality, rather than bettering it.

Further, some available digital image capture devices attempt to address some of these controls as a group, but they use static algorithms to do so. For example, such static algorithms will look at the preview of the current image and see what, if anything, can be done to improve it. Such techniques are mostly used for still image capture, and therefore do not concern themselves with why the image quality is suboptimal, and/or what subsequently captured images will look like.

Other available algorithms improve image quality after the image data has already been captured, using post-capture processing techniques (e.g., improving the brightness, saturation, contrast etc. of previously captured image data). However, such techniques are inherently limited in that information that was lost due to non-optimal factors at the time of capture cannot be retroactively retrieved. Instead, only finessing techniques (e.g., pixel averaging) can be used to present that data that has been captured in the most attractive form.

There is thus a need for an intelligent dynamic camera image quality engine, which can manage a set of controls as a group, and result in the capture of image data at the best possible quality in real-time. Further, an intuitive and convenient method and system will be needed, both for permitting the user to control various features, as well as for keeping the user apprised of various developments relating to image quality.

### BRIEF SUMMARY OF THE INVENTION

In accordance with one embodiment, the present invention is a system and method for an improving image quality for real-time capture of image data, where various parameters are controlled as a whole, and which implements algorithms based on an assessment of why the image quality is sub-optimal. In one embodiment, such a system and method includes the control of the capture parameters as well as image post-processing—potentially taking into account the previous images—thus enabling control over a wide-range of image quality aspects. In one embodiment, such a system and method is distributed between the device and the host system, thus enabling to take advantage of both the device capabilities as well as the host capabilities that are far superior to the device capabilities in general. This partitioning between the host and the device is unique in the context of digital cameras designed to be used in conjunction with a host system (e.g. Web Cameras).

Image quality for a digital camera is a combination of factors that can be traded off against each other. While it is easy in a known environment to tweak the camera to make it look better, the same settings will not work for all conditions. A system in accordance with an embodiment of the present invention intelligently manages various different parameters related to image quality, in order to improve the end-user experience by using awareness of the environment, system, and so on. The image quality engine updates a number of parameters, including some related to the host system (e.g. various host post-processing algorithms), some related to the camera (e.g., gain, frame rate), based upon knowledge about not only the current state of the system, but also knowledge about how the system got to its present state. Here the state of the system can include information coming from the device, information coming from the analysis of the frames and from the host itself (e.g.: CPU speed, application being used etc.).

In one embodiment, a system in accordance with the present invention includes a set of image processing features, a policy to control them based on system-level parameters, and a set of ways to interact with the user, also controlled by the policy. This architecture is flexible enough that it could evolve with time, as new features are added, or the behavior is updated. In one embodiment, the intelligent image quality engine is implemented as a state machine. The states in the state machine include information on when each state is entered, when it is exited, and what parameters are used for these algorithms.

In one embodiment, a smart auto-exposure (AE) algorithm is implemented which improves image quality in backlit environments, by emphasizing the auto-exposure in a zone of interest (e.g., the face of the user). The smart AE algorithm improves overall user experience by improving the image quality in the areas of the image that are important to the user (face and/or moving objects)., although the exposure of the rest of the image may potentially be degraded.

In one embodiment, a frame rate control algorithm is implemented, which improves image quality in low light environments. Other examples of image processing algorithms applied are controlling the saturation levels, brightness levels, contrast etc. In one embodiment, post-capture processing such as temporal filtering is also performed.

In one embodiment of the present invention, the user is asked for permission before specific algorithms are implemented. Moreover, in one embodiment, the user can also manually select values for certain parameters, and/or select certain algorithms for implementation.

In one embodiment of the present invention, one or more LEDs communicate information relating to the intelligent image quality engine to the user, such as when specific algorithms may be implemented to potentially improve the overall user experience, despite other tradeoffs.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram illustrating a system in accordance with an embodiment of the present invention.

FIG. 2 is a flowchart illustrating the functioning of a system in accordance with an embodiment of the present invention.

FIG. 3A is a block diagram representation of a state machine.

FIG. 3B illustrates an example of a state machine that is used in accordance with an embodiment of the present invention.

FIG. 4A is a flowchart illustrating various operations initiated by the state machine when the smart auto-exposure algorithm is implemented in accordance with an embodiment of the present invention.

FIG. 4B illustrates a sample zone of interest.

FIG. 5 is a graph illustrating the how frame rate, gain and de-saturation algorithms interact in accordance with an embodiment of the present invention.

FIG. 6 is a graph illustrating saturation control in accordance with an embodiment of the present invention.

FIG. 7A is a screen shot of a user interface in accordance with an embodiment of the present invention.

FIG. 7B is another screen shot of a user interface in accordance with an embodiment of the present invention.

FIG. 7C is a flowchart illustrating what happens when the user makes different choices in the UI.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the examples that follow focus on webcams, but that embodiments of the present invention could be applied to other image capturing devices as well.

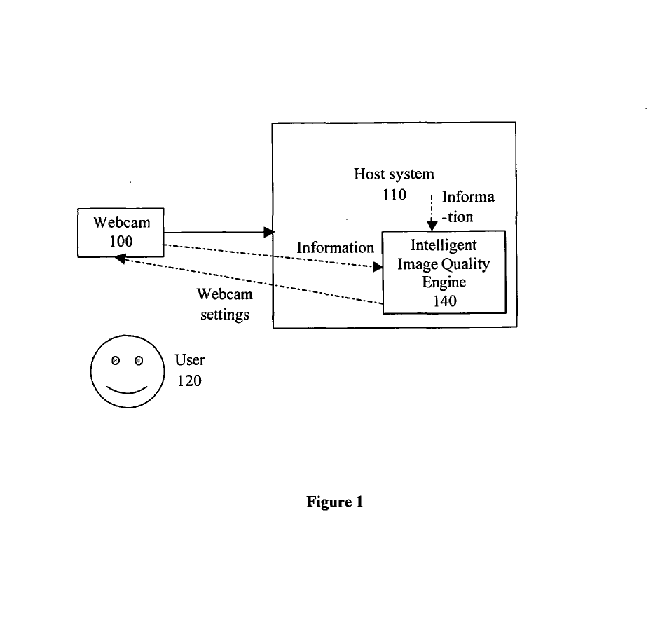

FIG. 1 is a block diagram FIG. 1 is a block diagram illustrating a possible usage scenario with an image capture device 100, a host system 110, and a user 120.

In one embodiment, the data captured by the image capture device 100 is still image data. In another embodiment, the data captured by the image capture device 100 is video data (accompanied in some cases by audio data). In yet another embodiment, the image capture device 100 captures either still image data or video data depending on the selection made by the user 120. The image capture device 100 includes a sensor for capturing image data. In one embodiment, the image capture device 100 is a webcam. Such a device can be, for example, a QuickCam® from Logitech, Inc. (Fremont, Calif.). It is to be noted that in different embodiments, the image capture device 100 is any device that can capture images, including digital cameras, digital camcorders, Personal Digital Assistants (PDAs), cell-phones that are equipped with cameras, etc. In some of these embodiments, host system 110 may not be needed. For instance, a cell phone could communicate directly with a remote site over a network. As another example, a digital camera could itself store the image data.

Referring back to the specific embodiment shown in FIG. 1, the host system 110 is a conventional computer system, that may include a computer, a storage device, a network services connection, and conventional input/output devices such as, a display, a mouse, a printer, and/or a keyboard, that may couple to a computer system. The computer also includes a conventional operating system, an input/output device, and network services software. In addition, in some embodiments, the computer includes Instant Messaging (IM) software for communicating with an IM service. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.). It is to be noted that the host system 10 could be any other type of host system such as a PDA, a cell-phone, a gaming console, or any other device with appropriate processing power.

In one embodiment, the device 100 may be coupled to the host 110 via a wireless link, using any wireless technology (e.g., RF, Bluetooth, etc.). In one embodiment, the device 100 is coupled to the host 110 via a cable (e.g., USB, USB 2.0, FireWire, etc.). It is to be noted that in one embodiment, the image capture device 100 is integrated into the host 110. An example of such an embodiment is a webcam integrated into a laptop computer.

The image capture device 100 captures the image of a user 120 along with a portion of the environment surrounding the user 120. In one embodiment, the captured data is sent to the host system 110 for further processing, storage, and/or sending on to other users via a network.

The intelligent image quality engine 140 is shown residing on the host system 110 in the embodiment shown in FIG. 1. In another embodiment, the intelligent image quality engine 140 is resident on the image capture device 100. In yet another embodiment, the intelligent image quality engine 140 partly resides on the host system 10 and partly on the image capture device 100.

The intelligent image quality engine 140 includes a set of image processing features, a policy to control them based on system-level parameters, and a set of ways to interact with the user, also controlled by the policy. Several image processing features are described in detail below. These image processing features improve some aspects of the image quality, depending on various factors such as the lighting environment, the movement in the images, and so on. However, image quality does not have a single dimension to it, and there are a lot of trade-offs. Specifically, several of these features, while bringing some improvement, have some drawbacks, and the purpose of the intelligent image quality engine 140 is to use these features appropriately depending on various conditions, including device capture settings, system conditions, analysis of the image quality (influenced by environmental conditions, etc.), and so on. In a system in accordance with an embodiment of the present invention, the image data is assessed, and a determination is made of the causes of poor image quality. Various parameters are then changed to optimize the image quality given this assessment, so that the subsequent images are captured with optimized parameters.

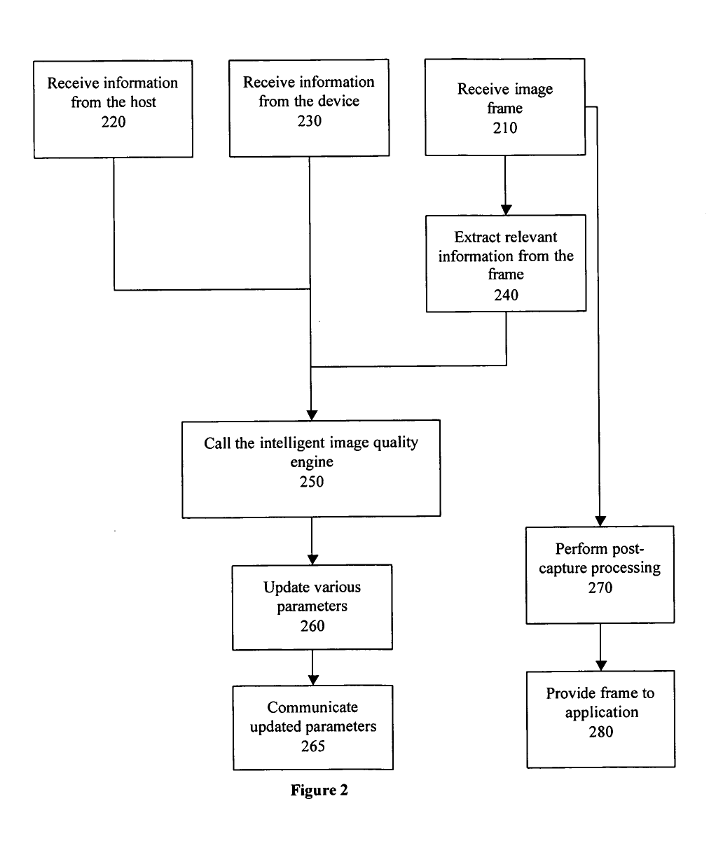

In order to make informed and intelligent decisions, the intelligent image quality engine 140 needs to be aware of various pieces of information, which it obtains from the captured image, the webcam 100 itself, as well as from the host 110. This is discussed in more detail below with reference to FIG. 2.

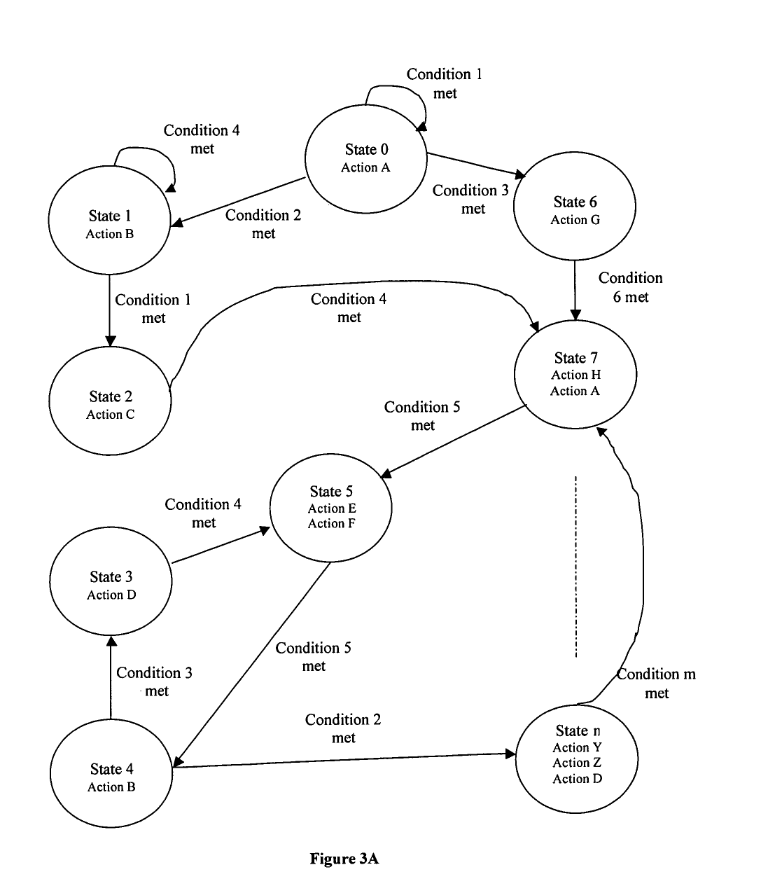

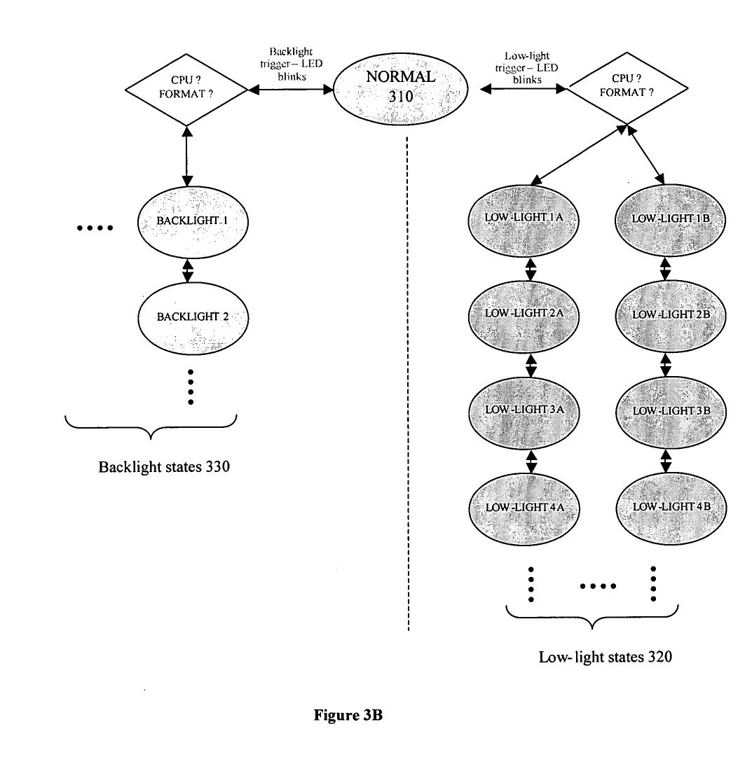

The intelligent image quality engine 140 is implemented in one embodiment as a state machine. The state machine contains information regarding what global parameters should be changed in response to an analysis of the information it obtains from various sources, and on the basis of various predefined thresholds. The state machine is discussed in greater detail below with respect to FIG. 3.

FIG. 2 is a flowchart that illustrates the functioning of a system in accordance with an embodiment of the present invention. It illustrates receiving an image frame (step 210), obtaining relevant information (steps 220, 230, and 240), calling the intelligent image quality engine (step 250), updating various parameters (step 260), communicating these updated parameters (step 265), post-processing the image (step 270), and providing the image to the application (step 280).

As mentioned above, a system in accordance with an embodiment of the present invention uses information gathered from various sources. An image frame is received (step 210). This image is captured using certain preexisting parameters of the system (e.g., gain of the device, frame rate, exposure time, brightness, contrast, saturation, white balance, focus)

Information is obtained (step 220) from the host 110. Examples of information provided to the intelligent image quality engine 140 by the host 110 include the processor type and speed of the host system 110, the format requested by the application to which the image data is being provided (including resolution and frame-rate), the other applications being used at the same time on the host system 110 (indicating the availability of the processing power of the host system 110 for the image quality engine 140 and also giving information about what the target use of the image could be), the country in which the host system 110 is located, current user settings affecting the image quality engine 140 etc. Information is obtained (step 230) from the device 100. Examples of information provided by the device 100 include the gain, frame rate, exposure and backlight evaluation (metric to evaluate backlight conditions. Examples of information extracted (step 240) from the image frame include the zone of interest, auto-exposure information (this can also be done in the device by the hardware or the firmware, depending on the implementation), backlight information (again, this can also be done in the device as mentioned above), etc. In addition, other information used can include focus, information regarding color content, more elaborate auto-exposure analysis to deal with images with non-uniform lighting images, and so on. It is to be noted that some of the information needed by the intelligent image quality engine can come from a source different from the one mentioned above, and/or can come from more than one source.

The intelligent image quality engine 140 is then called (step 250). Due to the received information, the intelligent image quality engine 140 analyzes, in one embodiment, not only whether the quality of the received image frame is poor, but also why this might be the case. For instance, the intelligent image quality engine can determine that the presence of backlight is what is probably causing the exposure of the image to be non-optimal. In other words, the intelligent image quality engine 140 not only knows where the system is (in terms of its various parameters etc.), but also the trajectory of how it got there (e.g., the gain was increased, then the frame rate was decreased, and so on). This is important because even if the result is the same (e.g., bad picture quality), different parameters may be changed to improve the image quality depending on the assessed cause of this result (e.g., backlighting, low light conditions, etc.). This is discussed below in more detail with respect to FIG. 3.

The parameters are then updated (step 260), as determined by the intelligent image quality engine 140. Some sets of parameters are continually tweaked in order to improved image quality in response to changing circumstances. In one embodiment, such continual tweaking of a set of parameters is in accordance with a specific image processing algorithm implemented in response to specific circumstances. For instance, a low light environment may trigger the frame rate control algorithm, and a back light environment may trigger the smart auto-exposure algorithm. Such algorithms are described in more detail below

Table 1 below illustrates an example of output parameters provided by an intelligent image quality engine 140 in accordance with an embodiment of the present invention.

```
TABLE 1
typedef struct _LVRL2_OUTPUT_PARAM
{
  LVRL_ULONG ulSmartAEMode; //new value of user control setting
  LVRL_ULONG ulSmartAEStrenght; //value to use for the Smart AE strenght
  LVRL_RECT SmartAEActualZOI; //filtered and adjusted zone of interest to use for
                                  //smart AE algorithm. This is in sensor coordinates.
  LVRL_ULONG ulTemporalFilterMode; //new value of user control setting
  LVRL_ULONG ulTemporalFilterIntensity; //value to use for the temporal filter
                                          //intensity
  LVRL_ULONG ulTemporalFilterCPULevel; //value to use for the temporal filter CPU
                                          //level. 0 to 10. 0 is low, 10 is high.
  LVRL_ULONG ulColorPipeAutoMode; //new value of user control setting
  LVRL_ULONG ulColorPipeIntensity;  //value to use for the image pipe control
                                      //intensity
  LVRL_ULONG ulColorPipeThreshold11 //value to use for the image pipe control
                                        //gain threshold1
  LVRL_ULONG ulColorPipeThreshold12 //value to use for the image pipe control
                                        //gain threshold2
  LVRL_ULONG ulLowLightFrameRate; //new value of user control setting
  LVRL_ULONG ulFrameRateControlEnable; //value to use for the Frame Rate Control
                                          //enable: 0 is OFF and 1 is ON
  LVRL_ULONG ulFrameRateControlFrameTime; //value to use for the Frame Rate Control
                                              //frame time
  LVRL_ULONG ulFrameRateControlMaximumGain; //value to use for the Frame Rate
                                                //Control Maximum Gain
} LVRL2_OUTPUT_PARAM, *PLVRL2_OUTPUT_PARAM;
```

These updated parameters are then communicated (step 265) appropriately (such as to the device 100, and host 110), for future use. Examples of such parameters are provided below in various tables. This updating of parameters results in improved received image quality going forward.

It is to be noted that in one embodiment of the present invention, the intelligent image quality engine 140 is called (step 230) on every received image frame. This is important because the intelligent image quality engine 140 is responsible for updating the parameters automatically, as well as for translating the user settings into parameters to be used by the software and/or the hardware. Further, the continued use of the intelligent image quality engine 140 keeps it apprised regarding which parameters are under its control and which ones are manual at any given time. The intelligent image quality machine 140 can determine what to do depending upon its state, the context, and other input parameters, and produce appropriate output parameters and a list of actions to carry out.

As can be seen from FIG. 2, certain types of post-capture processing is also performed (step 270) on the received frame. An example of such post-processing is temporal processing, which is described in greater detail below. It is to be noted that such post-processing is optional in accordance with an embodiment of the present invention. The image frame is then provided (step 280) to the application using the image data.

As mentioned above, in one embodiment of the present invention, the intelligent image quality engine 140 is implemented as a state machine. FIG. 3A is a block diagram representation of a state machine. The definition of a state machine is well-known to one of skill in the art. As can be seen from FIG. 3A, a state machine includes various states (States 1 . . . m), each of which may be associated with one or more actions (Actions A . . . Z). Actions are descriptions of one or more activities to be performed. Further, a transition indicates a state change and is described by a condition that would need to be fulfilled to enable the transition. Transition rules (conditions 1 . . . m) determine when to transition to another state, and to which state the transition should be.

In one embodiment of a state machine, when the state machine is invoked, it looks up the current state in the associated context and then uses a predefined table of function pointers to invoke the correct function for that state. The state machine implements all the required decisions, creates the proper output using other functions (if needed) that can be shared with other state functions if appropriate and if a transition occurs it updates the current state in the context so that the next time the state machine is invoked the new state is assumed. With this approach adding a state is as simple as adding an additional function, and changing a transition amounts to locally adjusting a single function.

In one embodiment, the various transitions depend on various predefined thresholds. The value of the specific thresholds is a critical component in the performance of the system. In one embodiment, these thresholds are specific to a device 100, while the state machine is generic across different devices. In one embodiment, the thresholds are stored on the device 100, while the state machine itself resides on the host 110. In this manner, the same state machine works differently for different devices, because of the different thresholds specified. In another embodiment, the state machine itself may have certain states that are not entered for specific devices 100, and/or other states that exist only for certain devices 100.

In one embodiment, the state machine is fully abstracted from the hardware via a number of interfaces. Further, in one embodiment, the state machine is independent of the hardware platform. In one embodiment, the state machine is not dependent on the Operating System (OS). In one embodiment, the state machine is implemented with cross platform support in mind. In one embodiment, the state machine is implemented as a static or dynamic library.

FIG. 3B illustrates an example of a state machine that is used in accordance with an embodiment of the present invention. As can be seen from FIG. 3, the states are divided into 3 categories: the normal state 310, the low-light states 320, and the backlight states 330. In this embodiment, each state corresponds to a new feature being enabled or a new parameter. Each feature is enabled for its corresponding state, as well as all the states with higher number. Two states can correspond to the same feature with different parameters. In that case, the highest state number overrules the previous feature parameter. In one embodiment, for each state, the following information is defined:
The feature being enabled (e.g., temporal filter, smart auto-exposure (AE), frame rate control)
The parameters for that feature (e.g., maximum frame time, desaturation value)
The parameter on which to trigger state transition. (e.g., gain, integration time, backlight measurement)
The threshold to transition to next state
The threshold to transition to previous state.

Table 2 below provides an example of how low light states are selected based on the processor speed and the image format expressed in pixels per second (Width×Height×FramesPerSecond) in different modes of the intelligent image quality engine 140 (OFF/Normal mode / Limited CPU mode).

TABLE 2

| | | | Limited |
|---|---|---|---|
| | OFF | Normal | CPU |
| CPU > 2 MHz | Off | Low- | Low- |
| or PPS < 1.5M | | LightA | LightB |
| CPU < 2 Mhz | Off | Low- | Low- |
| | | LightB | LightB |

Examples of Low-LightA and Low-LightB are provided in Tables 3 and 4 respectively.

TABLE 3
Low-light A

| | | | | Thresh- | Thresh- |
|---|---|---|---|---|---|
| | | | Trigger | old to | old to |
| State # | Feature | Parameters | parameter | disable | enable |
| LowLight1A | Temp. | CPU low | Gain | 2 | 3 |
| | Filter | | | | |
| LowLight2A | Frame | 1/10 s | Gain | 4 | 6 |
| | rate | Max Gain = 6 | | | |
| LowLight3A | Image | Intensity | Gain | 6 | 6.1 |
| | Controls | (50%) | | | |
| | | Gain thresh 1 | | | |
| | | Gain thresh 2 | | | |
| LowLight4A | Frame | ⅕ s | Gain | 6 | 8 |
| | rate | Max Gain = 8 | | | |
| LowLight5A | Temp. | CPU high | Gain | 10 | 12 |
| | Filter | | | | |

TABLE 4
Low-light B

| | | | | Thresh- | Thresh- |
|---|---|---|---|---|---|
| | | | Trigger | old to | old to |
| State # | Feature | Parameters | parameter | disable | enable |
| LowLight1B | Frame | 1/10 s | Gain | 2 | 3 |
| | rate | Max Gain = 3 | | | |
| LowLight2B | Image | Intensity | Gain | 3 | 3.1 |
| | Controls | (50%) | | | |
| | | Gain thresh 1 | | | |
| | | Gain thresh 2 | | | |
| LowLight3B | Frame | ⅕ s | Gain | 4 | 6 |
| | rate | Max Gain = 8 | | | |
| LowLight4B | Temp. | CPU low | Gain | 6 | 8 |
| | Filter | | | | |

As mentioned above, various reasons for poor image quality are addressed by various embodiments of the present invention. These include low light conditions, back light conditions, noise, etc. In addition, several image pipe controls (such as contrast, saturation etc.) can also be handled. These are now discussed in some detail below.

Smart Auto-Exposure (AE):

If image quality is assessed to be poor due to back-light situations, smart AE is invoked. Smart AE is a feature that improves the auto-exposure algorithm of the camera, improving auto-exposure in the area of the image most important to the user (the zone of interest). In one embodiment, the smart AE algorithm can be located in firmware. In one embodiment, this can be located in software. In another embodiment, it can be located in both the firmware and software. In one embodiment, the smart AE algorithm relies on statistical estimation of the average brightness of the scene, and for that purpose will average statistics over a number of windows or blocks with potentially user-settable size and origin.

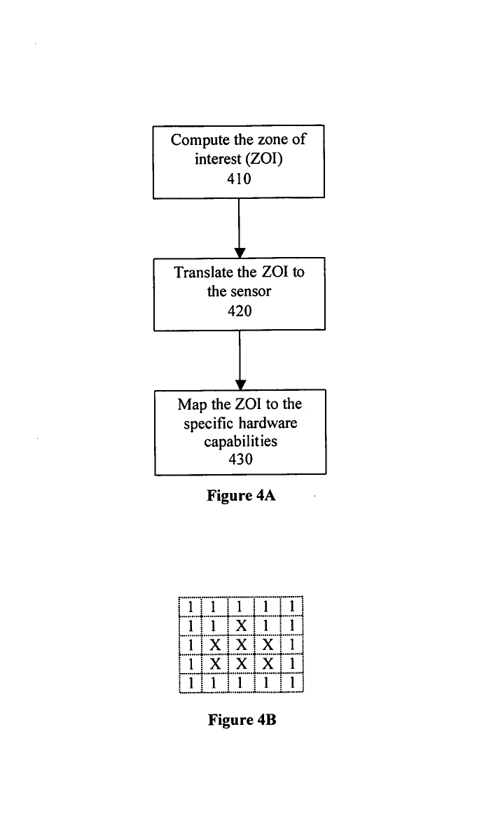

FIG. 4A is a flowchart that illustrates various operations initiated by the state machine when the smart auto-exposure algorithm is implemented in accordance with an embodiment of the present invention. In one embodiment, Smart AE is implemented as a combination of machine vision and image processing algorithms working together.

The zone (or region) of interest (ZOI) is first computed (step 410) based upon the received image. This zone of interest can be obtained in various ways. In one embodiment, machine vision algorithms are used to determine the zone of interest. In one embodiment, a human face is perceived as constituting the zone of interest. In one embodiment, the algorithms used to compute the region of interest in the image are a face-detector, face tracker, or a multiple face-tracker. Such algorithms are available from several companies, such as Logitech, Inc. (Fremont, Calif.), and Neven Vision (Los Angeles, Calif.). In one embodiment, a rectangle encompassing the user's face is compared in size with a rectangle of a predefined size (the minimum size of the ZOI). If the rectangle encompassing the user's face is not smaller than the minimum size of the ZOI, this rectangle is determined to be the ZOI. If it is smaller than the minimum size of the ZOI, the rectangle encompassing the user's face is increased in size until it matches or exceeds the minimum size of the ZOI. This modified rectangle is then determined to be the ZOI. In one embodiment, the ZOI is also corrected so that it does not move faster than a predetermined speed on the image in order to minimize artifacts caused by excessive adaptation of the algorithm. In another embodiment, a feature tracking algorithm, such as that from Neven Vision (Los Angeles, Calif.) is used to determine the zone of interest.

In yet another embodiment, when no zone of interest is available from machine vision, a default zone of interest is used (for instance, corresponding to the center of the image and 50% of its size). It is to be noted that in one embodiment, the zone of interest also depends upon the application for which the video captured is being used (e.g., for Video Instant Messaging, either the location of motion in the image, or location of the user's face in the image may be of interest). In one embodiment, the ZOI location module will output coordinates of a sub-window where the user is located. In one embodiment, this window encompasses the face of the user, and may encompass other moving objects as well. In one embodiment) the window is updated after every predefined number of milliseconds. In one embodiment, each coordinate cannot move by more than a predetermined number of pixels per second towards the center of the window, or by more than a second predetermined number of pixels per second in the other direction. Additionally, in one embodiment, the minimal window dimensions are no less than a predetermined number of pixels both horizontally and vertically of the sensor dimensions.

The zone of interest computed for the frame is then translated (step 420) into the corresponding region on the sensor of the image capture device 100. In one embodiment, when the ZOI is computed (step 410) in the host 110, it needs to be communicated to the camera 100. The interface used to communicate the ZOI is defined for each camera. In one embodiment, the auto-exposure algorithm reports its capacities in a bitmask for a set of different ZOIs. Then, the driver for the camera 100 posts the ZOI coordinates to the corresponding property, expressed in sensor coordinates. The driver knows the resolution of the camera, and uses this to translate (step 420) from window coordinates to sensor coordinates.

The ZOI is then mapped (step 430) to specific hardware capabilities depending on the AE algorithm used. For example if the AE algorithm uses a number of averaging zones on the sensor, the ZOI is made to match up as closely as possible to a zone made of these averaging zones. The AE algorithm will then use the zones corresponding to the ZOI with a higher averaging weight while determining exposure needs. In one embodiment, each averaging zone in the ZOI has a weightage which is a predetermined amount more that the other averaging zones (outside the ZOI) in the overall weighted average used by the AE algorithm. This is illustrated in FIG. 4B, where each averaging zone outside the ZOI has a weightage of 1, while each pixel in the ZOI has a weightage of X where X is larger than 1.

Table 5 below illustrates some possible values of some of the parameters discussed above for one embodiment of the smart AE algorithm.

TABLE 5

| Property | Type | Values | Effect |
|---|---|---|---|
| Strength | Discrete | 0, 1, 2, 3 | Decides on the |
| (X) | | | respective weights |
| | | | between the ZOI and |
| | | | the rest of the image |
| | | | (corresponds to |
| | | | weights of 4, 8, 16) 0 |
| | | | is used to turn the |
| | | | feature off |
| Frequency | Discrete | Multiple | Time difference |
| (T) | | of 1/30 s | between two updates |
| | | | of the ZOI coordinates |
| Max. | Continuous | Any | Number of pixel |
| Coord | | integer | difference between |
| Mov. | | below | successive coordinates |
| Inwards | | 500 | |
| (N) | | | |
| Max. | Continuous | Any | Number of pixel |
| Coord | | integer | difference between |
| Mov. | | below | successive coordinates |
| Outwards | | 500 | |
| (M) | | | |
| Min ZOI | Continuous | Any | Minimum ZOI size in |
| size (P) | | integer | pixels |
| | | below | |
| | | 1000 | |

In one embodiment, some of the above parameters are fixed across all image capture devices, while others vary depending on which camera is used. In one embodiment, some of the parameters can be set/chosen by the user. In one embodiment, some of the parameters are fixed. In one embodiment, some of the parameters are specific to the camera, and are stored on the camera itself.

In one embodiment, the smart auto-exposure algorithm reports certain parameters to the intelligent image quality engine 140 for example the current gain, with different units so that meaningful thresholds can be set using integer numbers. For example, in one embodiment, to allow sufficient precision, the gain is defined as an 8 bit integer, with 8 being a gain of 1, and 255 being a gain of 32.

In one embodiment, the smart auto-exposure algorithm reports to the intelligent image quality machine 140 an estimation of the degree to which smart AE is required (backlight estimation), by subtracting the average of the outside windows from the average of the center windows. For that purpose, in one embodiment the default size of the center window is approximately half the size of the entire image. Once the smart AE feature is enabled, that center window becomes the ZOI as discussed above. In one embodiment, this estimation of the degree to which smart AE is required is based on the ratio (rather than the difference), depending on the implementation between the average of the center and the average of the outside. In one embodiment, a uniform image will yield a small value, and the bigger the brightness difference between the center and the surrounding, the larger this value (regardless of whether the center or the outside is brighter)

Frame Rate Control:

When low light conditions are encountered, the frame rate control feature may be implemented in accordance with an embodiment of the present invention. This provides for a better signal-to-noise ratio in low-light conditions.

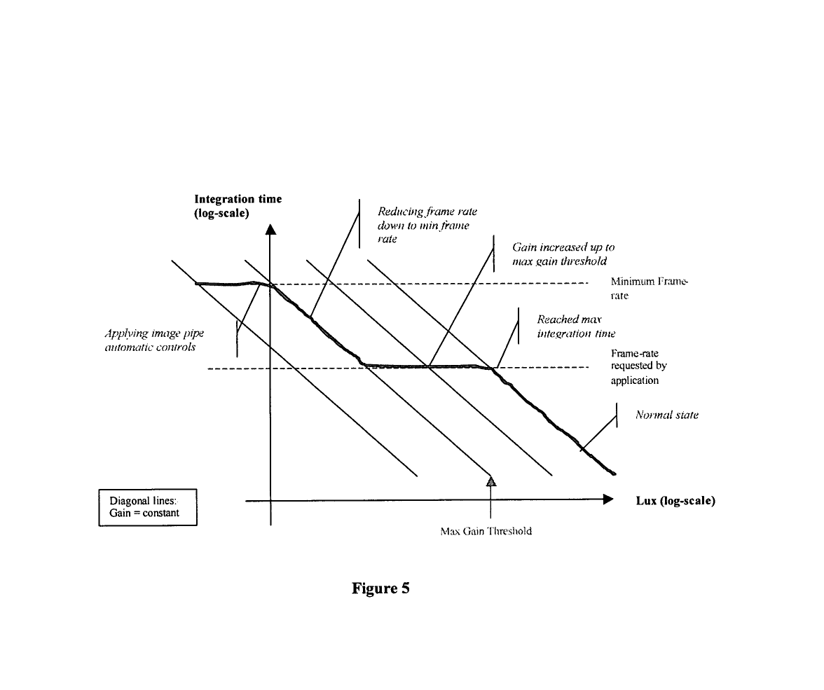

FIG. 5 is a graph illustrating the how frame rate, gain and de-saturation algorithms interact in accordance with an embodiment of the present invention. The X-axis in FIG. 5 represents the intensity of the lighting (in log scale), and the Y-axis represents the integration time (in log scale). When light available decreases (that is moving towards the left on the graph), the integration time is increased (frame rate is decreased) to compensate for the diminishing light. The frame rate being captured by the camera 100 is decreased in order to be able to increase the image quality by using longer integration times and smaller gains. However, very low frame rate is often not acceptable for several reasons, including deterioration of user experience, and frame-rates requested by applications.

When the frame rate requested by the application is reached, and the light available decreases further, the gain is increased (as depicted by the horizontal part of the plot) steadily. As the light available decreases even further, a point is reached (the maximum gain threshold) when increasing the gain further in not acceptable. This is because an increase in gain makes the image noisy, and the maximum gain threshold is the point when further increase in noisiness is no longer acceptable. If the available light decreases further beyond this point, then the frame rate is decreased again (integration time is increased). Finally, when the frame rate has been reduced to a minimum threshold (min frame rate), if available light is further decreased, other measures are tried. For instance, gain may be increased further, and/.or other image pipe controls are played with (for instance, desaturation may be increased, contrast may be manipulated, and so on).

In one embodiment, the frame rate algorithm has the parameters shown in Table 6.

TABLE 6

| Property | Type | Values | Effect |
|---|---|---|---|
| Enable | Binary | ON/ | Turns the feature on |
| | | OFF | or off |
| Maximum | Discrete | 0–255 | Maximum Integration |
| Frame | | | time allowed (in 1/s => 5 |
| Time | | | for 200 ms, 15 |
| | | | for 66 ms . . . ) which |
| | | | controls the frame- |
| | | | rate |
| Maximum | Discrete | 0–255 | The AE algorithm |
| Gain | | | should use gain over |
| | | | int. time up to that |
| | | | value |

When the maximum frame time is shorter than the maximum frame time corresponding to the frame rate requested by the application, in one embodiment this parameter is disregarded in order to optimize image quality (this is what happens on the left side of FIG. 5 after the gain has reached the maximum gain value allowed).

Image Pipe Controls

Several other features that are implemented in accordance with an embodiment of the present invention, and are discussed here under image pipe controls. Image pipe controls are a set of knobs in the image pipe that have an influence on image quality, and that may be set differently to improve some aspects of the image quality at the expense of some others. For instance, these include saturation, contrast, brightness, and sharpness. Each of these controls has some tradeoffs. For instance, controlling saturation levels trades colorfulness for noise, controlling sharpness trades clarity for noise, and controlling contrast trades brightness for noise. In accordance with embodiments of the present invention, the user specified level of a control will be met as much as possible, while taking into account the interplay of this control with several other factors, to ensure that the overall image quality does not degrade to unacceptable levels.

In one embodiment, these image pipe controls are controlled by the intelligent image quality machine 140. In another embodiment, a user can manually set one or more of the se image pipe controls to different levels, as discussed in further details below. In another embodiment, one or more image pipe controls can be controlled by both the user and the intelligent image quality engine, with the user's choice overruling that of the intelligent image quality engine.

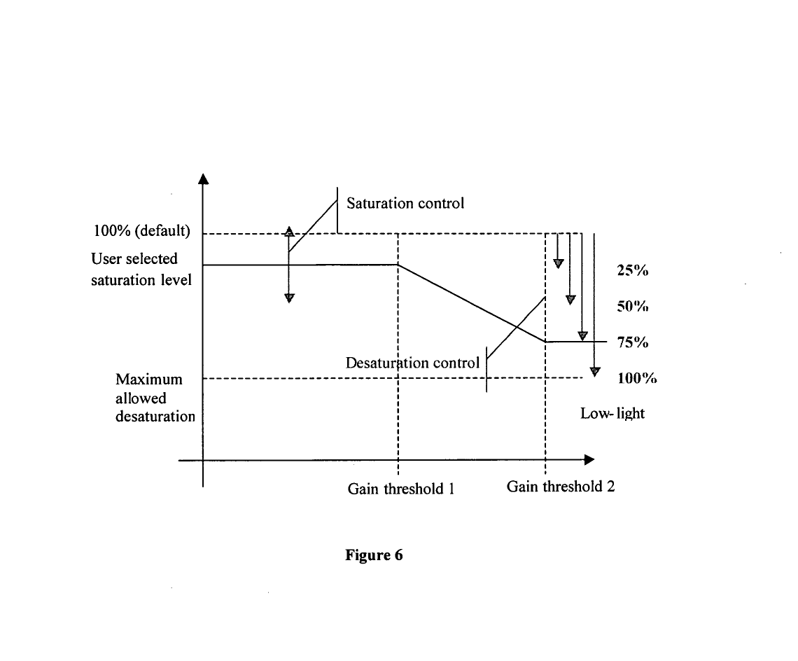

FIG. 6 is a graph that illustrates how a user specified level of saturation is implemented in accordance with an embodiment of the present invention. The saturation is plotted against the Y-axis, and the gain is plotted against the X-axis. In this embodiment, the user is given a choice of 4 levels of desaturation—25%, 50%, 75%, and 100% of a maximum allowed desaturation that is defined for each product. As can be seen, saturation when the gain is between threshold 1 and threshold 2 is interpolated between the user-selected level, and the level corresponding to the amount of reduction. In one embodiment, basically a linear interpolation is done to transition from the full saturation level to the reduced saturation level based on the gain. The two thresholds define the gain range over which the reduction of saturation is progressively applied. The saturation control is the standard saturation level set by the user, and the de-saturation control is the amount of de-saturation allowed by either the user or the intelligent image quality machine.

In one embodiment, the various controls are part of the image pipe, either in software or in hardware. Some of the parameters for the image pipe controls are in Table 7 below.

TABLE 7

| Property | Type | Values | Effect |
|---|---|---|---|
| Intensity | Continuous | 0, 1, 2, 3 | Determines how much |
| at | | | the value is decreased at |
| maximum | | | maximum gain. From |
| gain | | | that, the current value |
| | | | will be interpolated. 0 |
| | | | will be used to turn the |
| | | | feature off. 1, 2, 3 |
| | | | respectively correspond |
| | | | to 25%, 50% and 100% |
| | | | decrease of the image |
| | | | pipe controls |
| Gain | Continuous | 0–255 | Gain threshold at which |
| threshold 1 | | | to start modifying |
| | | | Intensity |
| Gain | Continuous | 0–255 | Gain threshold |
| threshold 2 | | | corresponding to |
| | | | modified Intensity |

Temporal Filter

As mentioned above with respect to FIG. 2, some post-capture processing on the image data is also performed (step 270) in accordance with some embodiments of the present invention. Temporal filtering is one such type of post-processing algorithm.

In one embodiment, the temporal noise filter is a software image processing algorithm that removes the noise by averaging pixels temporally in non-motion areas of the image. While temporal filtering reduces temporal noise in fixed parts of the image, it does not affect the fixed pattern noise. This algorithm is useful when the gain reaches levels at which noise becomes more apparent. In one embodiment, this algorithm is activated only when the gain level is above a certain threshold.

In one embodiment, temporal filtering has the parameters shown in Table 8:

TABLE 8

| Property | Type | Values | Effect |
|---|---|---|---|
| CPU | Binary | LOW/ | |
| level | | HIGH | |
| Intensity | Discrete | 0, 1, 2, 3 | Averages respectively |
| | | | over 2, 4 or 8 frames. 0 |
| | | | will be used to turn the |
| | | | feature off. |
| Noise | Continuous | 0–65535 | Discriminates between |
| level | | | motion and noise. The |
| | | | smaller, the less noise |
| | | | it will remove, the |
| | | | larger, the more motion |
| | | | artifacts will be seen. |

User Interface

In one embodiment, the default implemented in the image capture device 100 is that the intelligent image quality engine 140 is enabled, but not implemented without user permission. Initially the actions of the intelligent image quality engine 140 are limited to detecting conditions affecting the quality of the image (such as lighting conditions (low-light or backlight)), and/or using the features as long as they do not have any negative impact on user experience. However, in one embodiment, the user is asked for permission before implementing algorithms that make tradeoffs as described above.

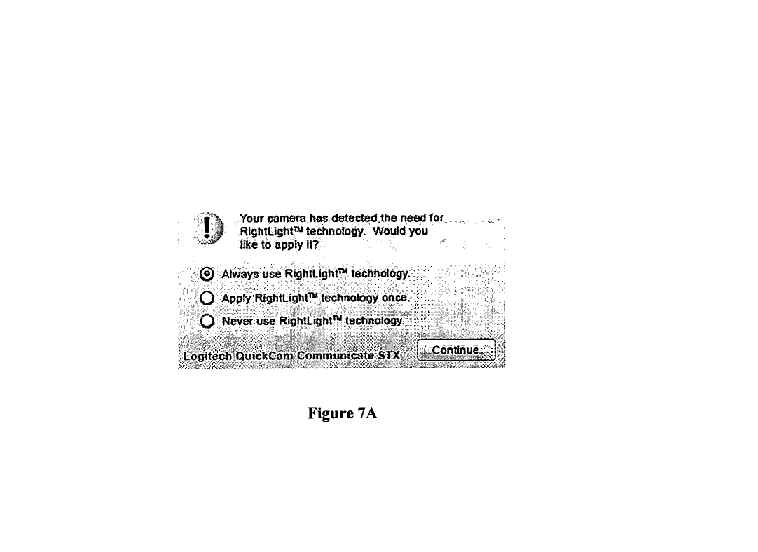

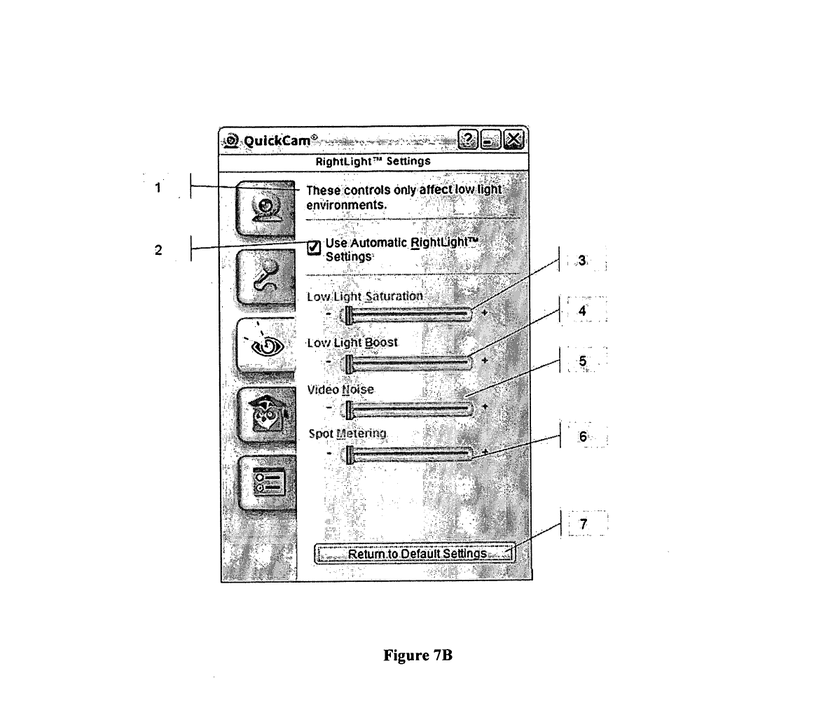

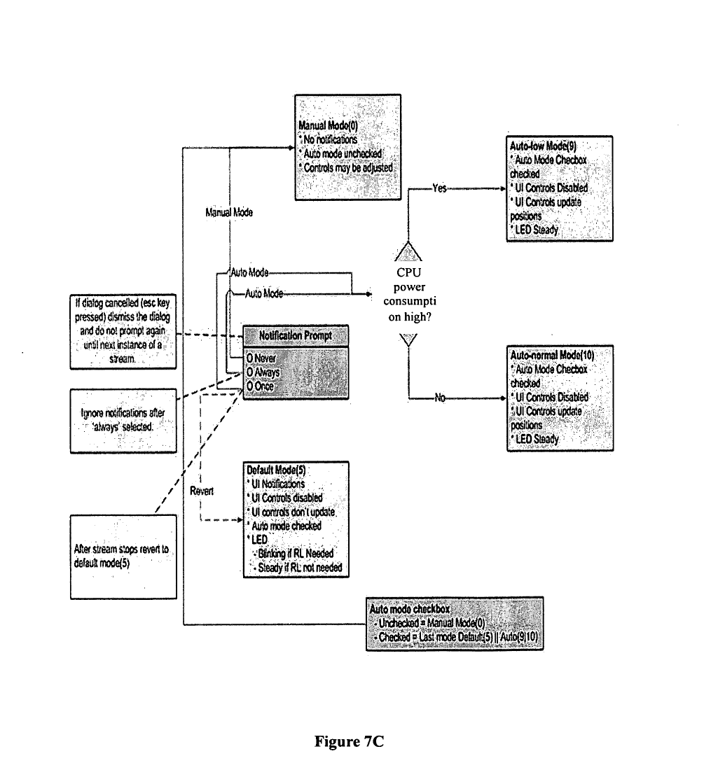

As mentioned above, improvements to the image quality that can be made without impacting the user experience are made automatically in one embodiment. When any of the triggers are reached requiring further improvements which will result in tradeoffs, the user 120 is asked whether to enable such features, and is informed about the negative effects, or given the option to optimize those himself. The user 120 is also asked, in one embodiment, whether he wants to be similarly prompted in future instances, or whether he would like the intelligent image quality engine to proceed without prompting him in the future. FIG. 7A shows a screen shot which, in accordance with an embodiment of the present invention, the user sees on a display associated with the host 110. In FIG. 7A, the intelligent image quality engine 140 is referred to as RightLight™.

In one embodiment, if the user 120 accepts the implementation of the intelligent image quality engine 140, and chooses not to be asked next time, then the intelligent image quality engine 140 will use various features in the future without notifying the user 120 again, unless the user 120 changes this setting manually. If the user 120 accepts the implementation of the intelligent image quality engine 140, but chooses to be notified next time, then the intelligent image quality engine 140 will use various features without notifying the user 120, until no such features including tradeoffs are needed, or the camera 100 is suspended or closed. If the user 120 refuses to use the intelligent image quality engine 140, then the actions taken will be limited to those that do not have any negative impact on the user experience.

In one embodiment, several of the features associated with the intelligent image quality engine 140 can also be manually set. FIG. 7B shows a user interface that the user 120 can use in accordance with one embodiment of the present invention, for selecting various controls, such as the low light saturation (corresponding to the image pipe control for desaturation described above), low light boost (corresponding to the frame rate control described above), video noise (corresponding to the temporal filter described above) and spot metering (corresponding to the smart AE described above). FIG. 7B allows the user 120 to set the levels of each of these by using slider controls. In one embodiment, a manually set user control will override the same parameter set by the intelligent image quality engine 140. In one embodiment, the slider controls are non-linear, and have a range between 0 (Off) to 3 (max). By default, they are all set to 0 (off). The behavior of the Auto-mode checkbox is discussed below with reference to FIG. 7C. Clicking on the Return to Default Settings button sets all sliders to the default mode. This is also discussed below with reference to FIG. 7C.

Table 9 below includes the mapping of User Interface (UI) controls to parameters in accordance with an embodiment of the present invention.

TABLE 9

| Feature | List of values | Mapping to parameters values |
|---|---|---|
| Temporal Filter | 0, 1, 2, 3 | Corresponds to the Intensity |
| | | parameter. 0 turns off that |
| | | feature, and 1, 2, 3 correspond |
| | | respectively to a 2, 4, and 8 |
| | | frames averaging |
| Low light boost | 0, 1, 2, 3 | Corresponds to the maximum |
| | | frame time in ms. 0 turns off the |
| | | feature, and 1, 2, 3 correspond |
| | | respectively to 100, 150 and 200 ms |
| | | maximum frame time. |
| | | Maximum gain to use will be |
| | | fixed. |
| Saturation | 0, 1, 2, 3 | Corresponds to the Intensity |
| | | parameter. 0 turns off the feature |
| | | (no change in the image pipe |
| | | with high gains) while values of |
| | | 1, 2, 3 will reduce the |
| | | parameters, 25%, 50% and 100% |
| | | of the range. |
| Smart AE | 0, 1, 2, 3 | Corresponds to the weight |
| | | parameter. 0 turns off the |
| | | feature, and 1, 2, 3 correspond |
| | | respectively to weights of 4, 8, |
| | | and 16. |

FIG. 7C is a flowchart illustrating what happens in one embodiment, when the user selects a choice in FIG. 7A and/or a slider position in FIG. 7B. In the embodiment shown here, when the driver for the device 100 is installed it will default to the Manual Mode (0). When the installer installs a RightLight™ monitor, it sets a registry key informing the driver that a RightLight™ UI is installed. This allows the driver to customize its property pages to display the correct set of controls. When the associated software first launches it will set the RightLight mode to Default Mode(5). The default mode (UI perspective) behaves as:
Auto mode button in FIG. 7B is checked
The slider controls is FIG. 7B are disabled and their values do not reflect the driver values
Notifications from the intelligent image quality engine 140 will prompt the software to display the prompt dialog shown in FIG. 7A.

As can be seen from FIG. 7A, the prompt dialog gives the user three options:
1. Always—Applies Mode 10. This allows the intelligent image quality machine 140 to control everything.
2. Once—Applies Mode 10. The software continues to process notifications from the intelligent image quality machine 140 and once the stream is terminated, the mode is set to Default (5). The user will only be prompted once per instance of a stream.
3. Never—Applies Mode 0. This puts the system in manual mode (unchecks the auto checkbox).

While in Auto mode (9 or 10) the UI behaves as:
Auto Mode checkbox in FIG. 7B checked
UI controls in FIG. 7B are disabled (user can not change them and they are dim)
UI controls are updated based on the intelligent image quality engine 140.

There is a distinction between auto modes 9 and 10. Mode 9 is the high power consumption by the CPU of the host system 110 mode, and 10 is the low power consumption by the CPU of the host system 110 mode. Other features/applications (e.g., intelligent face tracking, use of avatars, etc.) used affect the selection of these modes.

In one embodiment, these modes are stored on a per-device level in the application. If the user puts one camera in manual mode and plugs in a new camera, the new camera is initialized into the default mode. Plugging the old camera in will initialize it in the manual mode. If the user cancels (presses esc key) while the prompt dialog shown in FIG. 7A is open, the dialog will be closed with no change to the mode. There will be no further prompting of the user until the next instance of a stream.

In accordance with an embodiment of the present invention, an image capture device 100 is equipped with one or more LEDs. These LED(s) will be used to communicate to the user information regarding the intelligent image quality engine 140. For instance, in one embodiment, a steady LED is the default in normal mode. A blinking mode for the LED is used, in one embodiment, to give feedback to the user about specific modes the camera 100 may transition into. For instance, when none of the intelligent image quality algorithms (e.g., the frame rate control, the smart AE, etc.) are being implemented, the LED is green. When the intelligent image quality engine enters one of the states where such an algorithm will be implemented, the LED blinks. Blinking in this instance indicates that user interaction is required. When the user interaction (such as in FIG. 7A) is over, the LED goes back to green. In one embodiment, the settings of the LED is communicated from the host 110 to the intelligent image quality engine 140, and updated settings are communicated from the intelligent image quality engine 140 to the host 110, as discussed with reference to FIG. 2.

While particular embodiments and applications of the present invention have been illustrated and described, it is to be understood that the invention is not limited to the precise construction and components disclosed herein. For example, other metrics and controls may be added, such as software based auto-focus, different uses for the ZOI, more advanced backlight detection and AE algorithms, non uniform gain across the image etc. Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A system for capturing image data with improved image quality, the system comprising:
an image capture device communicatively coupled to a host system;
an intelligent image quality engine for controlling the quality of image data captured by the image capture device, wherein the intelligent image quality engine receives information from the image capture device and the host system, and provides parameters to the device.

2. The system of claim 1, further comprising:
the host system to which the image capture device is communicatively coupled.

3. The system of claim 1, wherein the intelligent image quality engine also provides parameters to the host system.

4. The system of claim 1, wherein the image capture device includes visual feedback indicators to provide information regarding the intelligent image quality engine.

5. A method for intelligently improving quality of image data captured by an image capture device, the image capture device communicatively coupled to a host, the method comprising:
receiving image data;
extracting information from the received image data;
receiving information from the image capture device, including a first parameter;
receiving information from the host, including a second parameter;
calling an intelligent image quality engine;
updating the first parameter and the second parameter as specified by the intelligent image quality engine; and
communicating the first parameter to the image capture device and the second parameter to the host.

6. The method of claim 5, wherein the first parameter is one from a group of consisting of a gain of the image capture device, a frame rate, and a backlight evaluation metric.

7. The method of claim 5, wherein the second parameter is one from a group consisting of an application using the image data, information regarding the processing power of the host, and information regarding settings of a plurality of algorithms applied by the host.

8. The method of claim 5, wherein the intelligent image quality is a state machine.

9. The method of claim 8, wherein the step of calling the intelligent image quality engine comprises:
determining the appropriate state in the state machine based on:
a current state of the state machine;
information received from the host; information received from the image capture device, and the image data received; and
a predetermined threshold for transitioning from the current state into a next state.

10. The method of claim 8, wherein a transition from a first state in the state machine to a second state in a state machine is based on a predetermined threshold.

11. The method of claim 10, wherein the predetermined threshold is specific to the image capture device.

12. A method for intelligently controlling the auto-exposure of image data captured by an image capture device, the method comprising:
receiving image data;
extracting information from the received image data;
receiving information from the image capture device, including a first parameter;
receiving information from the host, including a second parameter;
based on at least one from the group consisting of the extracted information, the first parameter, and the second parameter,
identifying a zone of interest including a plurality of pixels;
providing a first weight to the plurality of pixels in the zone of interest, and a second weight to a plurality of pixels outside the zone of interest.

13. The method of claim 12, wherein the step of analyzing the captured image data comprises:
detecting a user's face in the image data.

14. The method of claim 12, wherein the step of analyzing the captured image data comprises:
detecting motion in the image data.

15. The method of claim 12, wherein the step of identifying a zone of interest comprises:
identifying a user's face in the captured image;
computing the coordinates of a rectangle formed to encompass the user's face;
computing a size of the rectangle;
comparing the size of the rectangle to a predefined minimum size; and
in response to the size of the rectangle being larger than the predefined minimum size, setting the rectangle as the zone of interest.

16. A method for capturing image data of improved quality in a low light environment, the image data being provided to an application on a host to which the image capture device is communicatively coupled, the method comprising:
receiving image data;
extracting information from the received image data;
receiving information from the image capture device, including a first parameter;
receiving information from the host, including a second parameter;
based on at least one from the group consisting of the extracted information, the first parameter, and the second parameter,
decreasing the frame rate captured by the image capture device until a frame rate requested by the application is reached;
increasing a gain of the image capture device until a predefined maximum gain threshold is reached; and
further decreasing the frame rate captured by the image capture 17 device until a predefined frame rate threshold is reached.

17. The method of claim 16, further comprising:
increasing desaturation to further improve the quality of the image.

18. The method of claim 17, further comprising:
applying a temporal filter to further improve the quality of the image when a specified gain threshold is reached.
